(19) United States
(12) Patent Application Publication
(10) Pub. No.: US 2002/0033137 A1
(43) Pub. Date: Mar. 21, 2002

(54) Construction for automatically milking animals

(75) Inventors: Alexander van der Lely, Rotterdam (NL); Karel van den Berg, Bleskensgraaf (NL); Renatus Ignatius Josephus Fransen, Vlaardingen (NL)

Correspondence Address: Penrose Lucas Albright, Esq., MASON, MASON & ALBRIGHT, P.O. Box 2246, Arlington, VA, 22202-0246, US

(73) Assignee: Lely Enterprises A.G., a Swiss Limited Liability Company

(21) Appl. No.: 09/953,181

(22) Filed: Sep. 17, 2001

(30) Foreign Application Priority Data
Sep. 15, 2000 (NL) 1016196

(51) Int. Cl. A01J 3/00; A01J 5/00

(52) U.S. Cl. 119/14.1

(57) ABSTRACT

A construction for automatically milking animals is provided with a milking robot having at least one teat cup (2) and means (3 to 8) for connecting the teat cup(s) (2) to the teats of an animal to be milked. The construction comprises at least one milk collecting unit and at least one milking unit (1) which is movable relative to the milk collecting unit, said milking unit (1) being provided with own propulsion means (10, 11, 14, 15). The mobile milking units (1) may be disigned as light and compact ones. The own propulsion means of the milking units (1) result in a multifunctional construction.

The invention relates to a construction for automatically milking animals according to the preamble of claim 1.

Such a construction is known. The known constructions are rather cumbersome and restricted to the area where they are placed.

The invention aims at improving and further automatizing such a construction. According to the invention this is achieved by the measures mentioned in the characterizing part of claim 1. The milk collecting unit may serve as a master station for the mobile milking units. As a result thereof the milking units can be designed as light and compact ones. The own propulsion means of the milking units result in a multifunctional construction which can be used not only in a stable.

The invention will now be explained in further detail with reference to the accompanying figures.

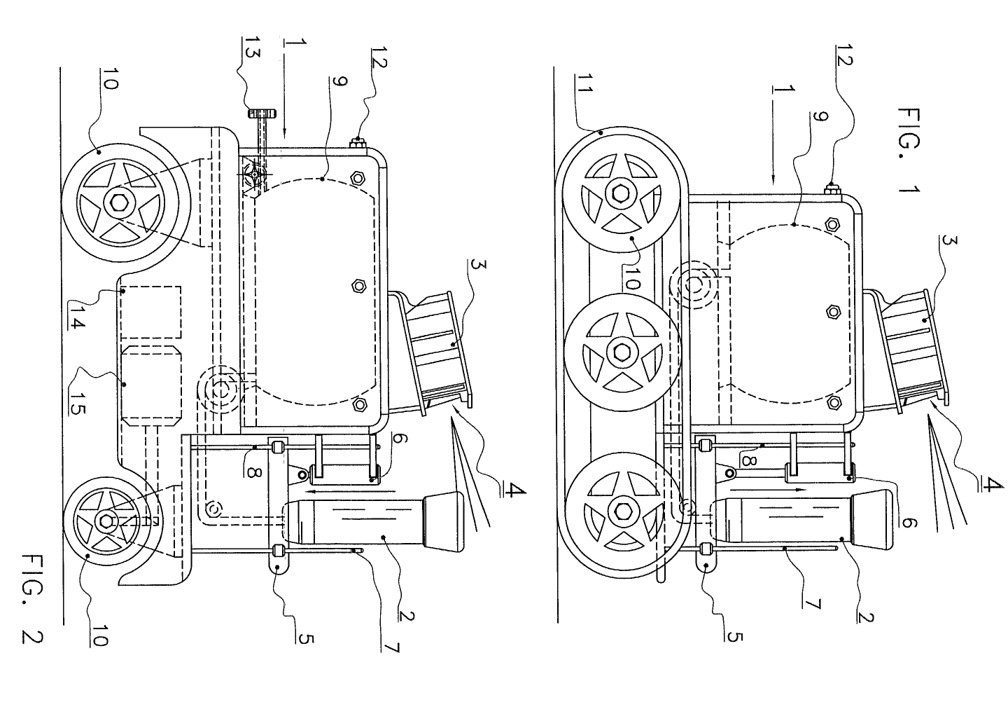

FIG. 1 is a schematic side view of a first embodiment of a milking unit according to the invention;

FIG. 2 is a schematic side view of a further embodiment of the milking unit;

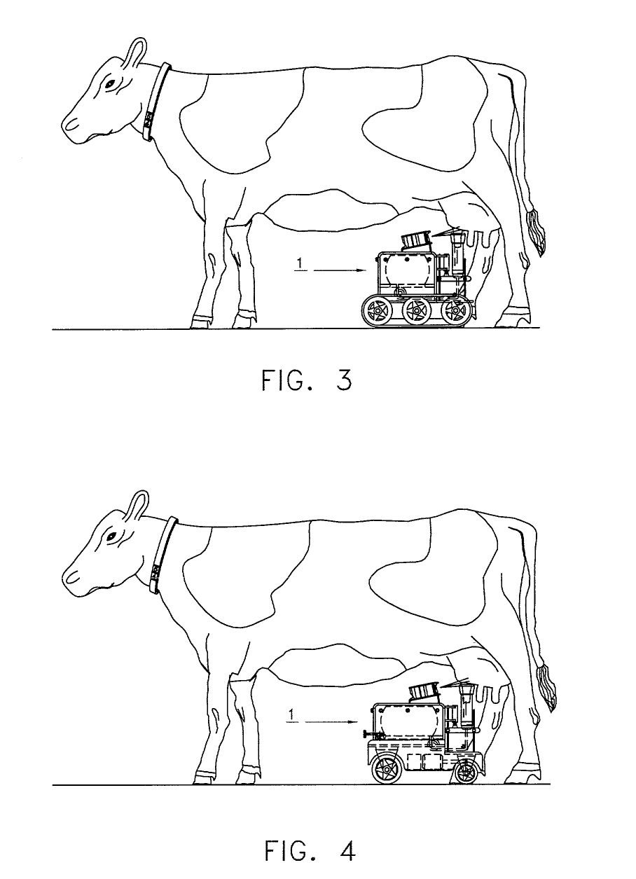

FIG. 3 shows the milking unit of FIG. 1 when it is being used, and

FIG. 4 shows the milking unit of FIG. 2 when it is being used.

The milk collecting unit may be designed in many different shapes and dimensions. Both mobile and stationary constructions are possible, their accessibility always being of importance for the milking units. Apart from the characteristics described hereinafter there are hardly restrictions for the construction of the milk collecting unit, which is not shown in further detail. The milk collecting unit is preferably provided with a milk reservoir, with energy supply means for the milking units, with underpressure and/or overpressure supply means for the milking units, with milk analysing means, with cleaning and/or disinfecting means for the milking units, in particular for the teat cups, and with equipment for controlling the milking units, such as a computer with appropriate communication means.

The milking unit 1 shown in FIG. 1 is provided with one teat cup 2 and with the means for connecting the teat cup 2 to the teats of an animal to be milked. These means known per se comprise a laser sensor 4 disposed in a housing 3 for detecting the position of the teats of the animal to be milked relative to the teat cup 2, and further a lifting device for the teat cup 2, said lifting device comprising a platform 5, a cylinder 6 and guide elements 7 and 8. The construction is suitable for positioning the milking unit 1 on the basis of data from the laser sensor 4 in such a manner that the lifting device can connect the teat cup 2 to the teat of the animal to be milked by means of a substantially vertical movement.

In the depicted embodiment the milking unit 1 is provided with one teat cup 2. Of course, there may also be provided two or four teat cups. The milking unit 1 is further provided with a milk tank 9 which is connected to the teat cup 2 and which is suitable for being connected to the milk reservoir of the milk collecting unit, so that the milk tank 9 is able to supply regularly or when required the milk collected therein. The milking unit 1 is further provided with (non-shown) storage means for energy (such as an accumulator) and/or overpressure and/or underpressure. The milking unit 1 may also be provided with a camera (e.g. for navigation or positioning purposes).

The own propulsion means of the milking unit 1 comprise drive means, such as a motor, and steering means. The milking unit 1 is provided with wheels or rollers 10 and caterpillar tracks 11 and is suitable for moving across the ground in a rolling manner. There may also be provided an air cushion construction, so that the milking unit 1 can move across the ground in a hovering manner.

The construction preferably comprises navigation means (such as a computer with appropriate data) which are suitable for determining a course to be followed for the milking unit 1 and which are suitable for making the milking unit 1 follow a certain course with the aid of the propulsion means. The milk collecting unit and/or the milking unit 1 may be provided with means for locating an animal, said means being suitable for co-operating with positioning means (such as GPS or DGPS) provided near, on or in the animal. The milking unit 1 is further suitable for approaching and possibly following the animal on the basis of data from the means for locating an animal.

In a non-shown embodiment the milking unit 1 is provided with means for coupling at least a part of the milking unit 1, not being constituted by a teat cup 2, to an animal to be milked. Said means may comprise at least one gripping arm which is suitable for gripping the trunk and/or at least one leg of the animal. In this case the milking unit 1 is suitable for remaining connected with the animal during a possibly adjustable time interval after coupling. Said time interval may also depend on the duration of the milking process and/or the duration of the connection of the teat cup(s). The construction is suitable for activating the means for connecting the teat cup(s) 2 after coupling. When the milking unit 1 is designed as a light one, the means for coupling may be suitable for suspending the milking unit (1) as a whole from the animal to be milked.

In an embodiment of the invention the milking unit 1 is provided with lure means for an animal to be milked. In a further embodiment the construction (the milk collecting unit and/or the milking unit 1) is provided with means for summoning an animal to be milked. The milking unit 1 may also be provided with repelling means for keeping animals that are not to be milked for the time being at a distance.

The milking unit 1 is preferably provided with transmitting and/or receiving means for transmitting and/or receiving data to and/or from the milk collecting unit. The construction may be provided with transmitting and/or receiving means for transmitting and/or receiving data to and/or from an animal to be milked.

The milking unit 1 is provided with sensor means 12 for registering movements and/or displacements of the animal to be milked and is suitable for tracking the animal to be milked with the aid of data from the sensor means 12. When, as depicted, the milking unit 1 is not designed with gripping arms, the vehicle 1 can track the animal in this manner during milking, if necessary.

FIG. 2 shows another embodiment of the milking unit 1. In this embodiment the wheels 10 are designed as swivelling wheels. The milk tank 9 is provided with a connecting piece 13 for the milk reservoir of the milk collecting unit. Further the accumulator 14 and the motor 15 are depicted.

FIGS. 3 and 4 illustrate the above-described embodiments of the milking unit 1 in a situation in which they are being used. The unmanned vehicle 1 can be controlled by means of a computer in such a manner that it traces and possibly tracks a located animal to be milked, connects the teat cup(s) 2 after assuming the appropriate position relative to the udder of the animal and milks the animal. The milk is stored in the milk tank 9 which can be emptied, regularly or when it is (almost) filled completely, into the milk reservoir of the milk collecting unit. Also for cleaning, energy supply and the like the milking unit 1 can be served by the milk collecting unit. As a result thereof the milking units 1 can be designed as very light and compact ones.

1. A construction for automatically milking animals, said construction being provided with a milking robot having at least one teat cup (2) and means (3 to 8) for connecting the teat cup(s) (2) to the teats of an animal to be milked, characterized in that the construction comprises at least one milk collecting unit and at least one milking unit (1) which is movable relative to the milk collecting unit and which is provided with own propulsion means (10, 11, 14, 15).

2. A construction as claimed in claim 1, characterized in that the milk collecting unit is provided with a milk reservoir.

3. A construction as claimed in claim 1 or 2, characterized in that the milk collecting unit is provided with energy supply means for the milking unit (1).

4. A construction as claimed in any one of claims 1 to 3, characterized in that the milk collecting unit is provided with underpressure and/or overpressure supply means for the milking unit (1).

5. A construction as claimed in any one of claims 1 to 4, characterized in that the milk collecting unit is provided with milk analysing means.

6. A construction as claimed in any one of claims 1 to 5, characterized in that the milk collecting unit is provided with cleaning and/or disinfecting means for the milking unit (1), in particular for one or a plurality of teat cups (2).

7. A construction as claimed in any one of claims 1 to 6, characterized in that the milk collecting unit is provided with equipment for controlling the milking unit (1), such as a computer with appropriate communication means.

8. A construction as claimed in any one of claims 1 to 7, characterized in that the milking unit (1) is provided with the at least one teat cup (2) and with the means (3 to 8) for connecting the teat cup(s) (2) to the teats of an animal to be milked.

9. A construction as claimed in any one of claims 1 to 8, characterized in that the milking unit (1) is provided with one teat cup (2).

10. A construction as claimed in any one of claims 1 to 9, characterized in that the milking unit (1) is provided with a milk tank (9) which is suitable for being connected to the milk reservoir of the milk collecting unit.

11. A construction as claimed in any one of claims 1 to 10, characterized in that the milking unit (1) is provided with storage means for energy (14) and/or overpressure and/or underpressure.

12. A construction as claimed in any one of claims 1 to 11, characterized in that the milking unit (1) is provided with a camera.

13. A construction as claimed in any one of claims 1 to 12, characterized in that the propulsion means (10, 11, 14, 15) comprise drive means (15).

14. A construction as claimed in any one of claims 1 to 13, characterized in that the propulsion means (10, 11, 14, 15) comprise steering means (10, 11).

15. A construction as claimed in any one of claims 1 to 14, characterized in that the construction is provided with navigation means.

16. A construction as claimed in claim 15, characterized in that the navigation means are suitable for determining a course to be followed for the milking unit (1).

17. A construction as claimed in claim 15 or 16, characterized in that the navigation means are suitable for making the milking unit (1) follow a certain course with the aid of the propulsion means (10, 11, 14, 15).

18. A construction as claimed in any one of claims 1 to 17, characterized in that the construction is provided with means for locating an animal.

19. A construction as claimed in claim 18, characterized in that the locating means are suitable for co-operating with positioning means provided near, on or in the animal.

20. A construction as claimed in claim 18 or 19, characterized in that the milking unit (1) is suitable for approaching and possibly tracking the animal on the basis of data from the means for locating an animal.

21. A construction as claimed in any one of claims 1 to 20, characterized in that the milking unit (1) is provided with means for coupling at least a part of the milking unit (1), not being constituted by a teat cup (2), to an animal to be milked.

22. A construction as claimed in claim 21, characterized in that the coupling means comprise at least one gripping arm.

23. A construction as claimed in claim 22, characterized in that the gripping arm is suitable for gripping the trunk and/or at least one leg of the animal.

24. A construction as claimed in any one of claims 21 to 23, characterized in that the milking unit (1) is suitable for remaining connected to the animal during a time interval after coupling.

25. A construction as claimed in claim 24, characterized in that the time interval is adjustable.

26. A construction as claimed in claim 24 or 25, characterized in that the time interval depends on the duration of the milking process and/or the duration of the connection of the teat cup(s) (2).

27. A construction as claimed in any one of claims 21 to 26, characterized in that the construction is suitable for activating the means for connecting the teat cup(s) (2) after coupling.

28. A construction as claimed in any one of claims 1 to 27, characterized in that the milking unit (1) is provided with wheels (10), rollers, caterpillar tracks (11) and/or an air cushion construction and is suitable for moving across the ground in a rolling and/or a hovering manner.

29. A construction as claimed in any one of claims 1 to 28, characterized in that the milking unit (1) is provided with a motor (15).

30. A construction as claimed in any one of claims 1 to 29, characterized in that the milking unit (1) is provided with lure means for an animal to be milked.

31. A construction as claimed in any one of claims 1 to 30, characterized in that the construction is provided with means for summoning an animal to be milked.

32. A construction as claimed in any one of claims 1 to 31, characterized in that the milking unit (1) is provided with repelling means for keeping animals that are not to be milked for the time being at a distance.

33. A construction as claimed in any one of claims 1 to 32, characterized in that the milking unit (1) is provided with transmitting and/or receiving means for transmitting and/or receiving data to and/or from the milk collecting unit.

34. A construction as claimed in any one of claims 1 to 33, characterized in that the construction is provided with transmitting and/or receiving means for transmitting data to and/or from an animal to be milked.

35. A construction as claimed in any one of claims 1 to 34, characterized in that the milking unit (1) is provided with sensor means (12) for registering movements and/or displacements of the animal to be milked.

36. A construction as claimed in claim 35, characterized in that the milking unit (1) is suitable for tracking the animal to be milked with the aid of data from the sensor means (12).

37. A construction as claimed in any one of claims 21 to 36, characterized in that the means for coupling are suitable for suspending the milking unit (1) as a whole from the animal to be milked.
